(19) United States
(12) Patent Application Publication
(10) Pub. No.: US 2026/0118190 A1
(43) Pub. Date: Apr. 30, 2026

(54) MAGNETORESISTOR BASED TACTILE SENSOR

(71) Applicants: Kevin Haocheng Qiu, MAPLE GROVE, MN (US); Jiaoming Qiu, MAPLE GROVE, MN (US)

(72) Inventors: Kevin Haocheng Qiu, MAPLE GROVE, MN (US); Jiaoming Qiu, MAPLE GROVE, MN (US)

(21) Appl. No.: 18/929,618

(22) Filed: Oct. 29, 2024

(51) Int. Cl. G01L 1/12; G01L 5/00

(52) U.S. Cl. CPC G01L 1/12; G01L 5/0061

(57) ABSTRACT

A tactile sensor device is disclosed. In one embodiment, giant magnetoresistance (GMR) sensors form multiple Wheatstone bridges on a base substrate to detect a magnetic field generated by a nearby ferromagnet. This ferromagnet is embedded within an elastomer matrix that deforms upon contact with an external object, displacing the ferromagnet. Consequently, the GMR sensors detect changes in the magnetic field resulting from the ferromagnet's displacement, thereby quantifying the contact.

### BACKGROUND

### 1. Technical Field

The present teaching relates to the methods and systems of tactile sensors and sensor arrays. Particularly, the present teaching is directed at the methods and systems of tactile sensors or sensor arrays with ferromagnets and magnetoresistance sensors.

### 2. Discussion of Technical Background

Human interactions with the environment are facilitated by a complex sensory system-a network of cells and nerves that detect stimuli such as light, sound, taste, smell, and touch. A crucial element in this system is the skin, which contains mechanoreceptors that sense pressure and touch. In the development of humanoid robots, touch sensors have lagged behind other sensors, such as cameras for light and microphones for sound. Consequently, humanoid robots have yet to achieve the refined dexterous manipulation that even infants are capable of.

A practical tactile sensing solution must meet several key requirements. First, the sensor should make conformal contact with objects that the robot is intended to grasp or manipulate. It must accurately detect contact forces, including compression and shear, with sufficient precision. Additionally, the frequency of contact detection should be high enough to allow the robot to adjust its actions in real-time. Contact sensors or sensor arrays should provide extensive surface coverage and high spatial resolution to mimic human response. However, most existing tactile sensor technologies still face significant limitations in enabling robots to adjust their grip effectively. For instance, capacitance-based tactile sensors lack the ability to gather directional information, which is essential for detecting slippage. Meanwhile, some recent tactile sensors developed with magnetic sensors are relatively expensive, limiting their potential for mass production.

To address the above challenges, a tactile sensor incorporating ferromagnets and magnetoresistance sensors, as described below, offers a practical solution for developing humanoid robots for a range of applications.

### SUMMARY

This disclosure pertains to methods and systems for tactile sensors and sensor arrays, specifically focusing on those that utilize ferromagnets and magnetoresistance sensors.

In one embodiment, a method for creating a device implemented on a robot or machine equipped with at least one processor and data storage is described. The device may be utilized solely for sensing purposes or may also possess data processing capabilities. Four magnetoresistance sensors are configured to form a bridge circuit, with two of the sensors shielded from external magnetic fields. The other two sensors respond to external magnetic fields by varying their resistance accordingly, with the change in resistance being proportional to the strength of the external magnetic field. Four of these bridge circuits and a ferromagnet embedded in an elastomer matrix constitute a tactile sensor. The elastomer matrix deforms in response to an applied external force, causing the ferromagnet to displace. This displacement alters the magnetic field produced by the ferromagnet, changing its strength and distribution, which can be detected by the tactile sensor. The sensor signals are then used to derive information about the applied external force, such as its magnitude and direction, enabling the robot or machine to respond appropriately.

In another embodiment, four magnetoresistance sensors are configured to form a bridge circuit, with two of the sensors shielded from external magnetic fields. A flux concentrator is positioned adjacent to the unshielded magnetoresistance sensors. Together, these four bridge circuits with field concentrators and a ferromagnet embedded in an elastomer matrix constitute a tactile sensor. The elastomer matrix deforms in response to an applied external force, resulting in the displacement of the ferromagnet. This displacement alters the magnetic field produced by the ferromagnet, changing its strength and distribution, which can be amplified by the flux concentrators and subsequently detected by the tactile sensor. The sensor signals are then utilized to derive information about the applied external force, including its magnitude and direction, enabling the robot or machine to respond accordingly.

In yet another embodiment, a tactile sensor array device is presented. This device consists of a base on which multiple sets of the aforementioned bridge circuits are arranged, along with a plurality of ferromagnets embedded in various elastomer matrices. These elastomer matrices deform in response to applied external forces, causing the embedded ferromagnets to displace accordingly. The different signals collected by the tactile sensor arrays are then used to derive information about the applied external forces, including their magnitude, direction, and spatial distribution, enabling the robot or machine to respond effectively.

Other concepts pertain to software for touch quantification. A software product, in accordance with this concept, includes at least one non-transitory machine-readable medium containing information. This information may consist of executable program code and data related to parameters associated with a request or operational parameters, such as information pertaining to a user, a request, a social group, or other relevant data.

### BRIEF DESCRIPTION OF THE DRAWINGS

The methods, systems, and/or programming described herein are elaborated upon through exemplary embodiments. These embodiments are presented in detail with reference to the accompanying drawings. It is important to note that these are non-limiting exemplary embodiments, in which similar reference numerals denote corresponding structures throughout the drawings, and wherein:

FIG. 1 (PRIOR ART) depicts an exemplary structure and characteristics of a giant magnetoresistance (GMR) sensor;

FIG. 2 illustrates two exemplary configurations of the bridge circuit with four magnetoresistance sensors setup, one without a flux concentrator while the other with a flux concentrator, according to an embodiment of the present teaching;

FIG. 3 illustrates one exemplary configuration of the tactile sensor setup without flux concentrators, according to one embodiment of the present teaching;

FIG. 4 illustrates another exemplary configuration of the tactile sensor setup with flux concentrators, according to another embodiment of the present teaching;

FIG. 5 illustrates one exemplary configuration of how the tactile sensor, the ferromagnet, and a planar elastomer matrix are formed on a substrate, either rigid or flexible;

FIG. 6 illustrates another exemplary configuration of how the tactile sensor, the ferromagnet, and a cone-shaped elastomer matrix are formed on a substrate, either rigid or flexible;

FIG. 7 illustrates how the tactile sensor is connected with other hardware such as a printed circuit board (PCB) and a computer for power supply, data collection and communication.

### DETAILED DESCRIPTION

In the following description, numerous specific details are provided through examples to facilitate a comprehensive understanding of the relevant teachings. However, it should be clear to those skilled in the field that the present teachings can be implemented without these details. In other cases, well-known methods, procedures, systems, components, and circuitry are discussed at a high level without extensive details to avoid unnecessarily obscuring key aspects of the present teachings.

The present disclosure outlines the methods and systems associated with a tactile sensor capable of detecting applied compressive and/or shear forces. The methods and systems described herein are designed to enhance a user's experience in detecting contact or touch.

A giant magnetoresistance (GMR) sensor offers a high level of precision in detecting magnetic fields and their subtle variations. It has been utilized in various applications, including magnetic storage devices, medical devices such as pacemakers, and the detection of biological or chemical processes involving magnetic particle labels. When magnetic objects are in close proximity to GMR sensors, these sensors can detect the magnetic field generated by the objects with exceptional accuracy. By using a pre-configured sensor layout, it is possible to determine the distance between the sensor and the magnetic object, as well as their relative position, by solving the relevant physics equations. An array of magnetic sensors can be integrated onto the same chip on a printed circuit board (PCB) that hosts other electronic components, creating a fully functional sensor device.

Various embodiments of the present teaching disclose methods and systems for creating a tactile sensor. A plurality of magnetic sensors is configured to detect magnetic fields generated by ferromagnets that are in close proximity to these sensors. Each ferromagnet is embedded in an elastomer matrix. When the elastomer matrices come into physical contact with solid surfaces, they deform and displace the embedded ferromagnets. The magnetic sensors detect changes in the magnetic field of each ferromagnet before and after contact occurs and send this data to a processing device to quantify the contact. The device can provide information about the direction of contact, the strength of the encountered force, and their distribution across the tactile sensors using predefined algorithms.

Additional novel features will be partially explained in the description that follows and will also become apparent to those skilled in the field upon examining the subsequent content and accompanying drawings. The novel aspects of the present teaching can be realized and achieved through the practice or use of various methodologies, tools, and combinations outlined in the detailed examples discussed below.

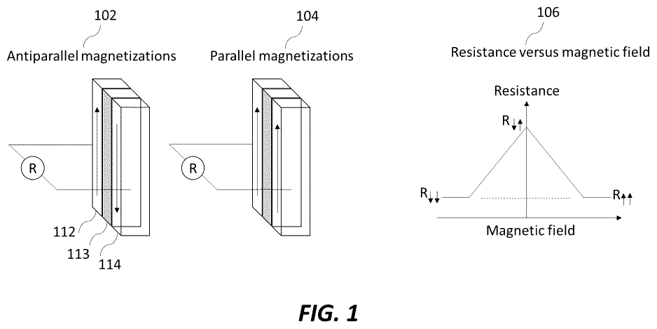

FIG. 1 (PRIOR ART) illustrates an exemplary structure and characteristics of a GMR magnetic field sensor. A GMR sensor is a type of magnetic field sensor that operates based on the giant magnetoresistance effect. When two magnetic layers are separated by a thin nonmagnetic layer, their relative magnetization directions-whether parallel or antiparallel-result in different resistance states. As shown in FIG. 1, a GMR sensor consists of three layers: two ferromagnetic layers 112 and 114 made of cobalt (Co), separated by a nonmagnetic layer 113 made of copper (Cu). The resistance associated with parallel magnetization 104 is lower than the resistance associated with antiparallel magnetization 102.

To take advantage of the GMR effect, the three-layered structure depicted in FIG. 1 can be physically patterned into long stripes. The magnetization of either the top or bottom ferromagnetic layers will align with the shape of the stripes due to a phenomenon known as shape anisotropy. As a result, the long-axis direction of this GMR sensor is more sensitive to changes in the magnetic field and is referred to as the easy axis. The relationship between the resistance of the GMR stripe and the applied magnetic field is illustrated in 106. The resistance peaks at zero magnetic field and reaches its minimum when the field strength is sufficiently high, regardless of the field's direction (i.e., positive or negative).

One GMR stripe exhibits a limited change in resistance under practical conditions. To amplify this effect, multiple GMR stripes can be connected in parallel, forming what is known as a serpentine structure. This configuration allows the resistance changes to accumulate, thereby enhancing the sensor's response to the magnetic field.

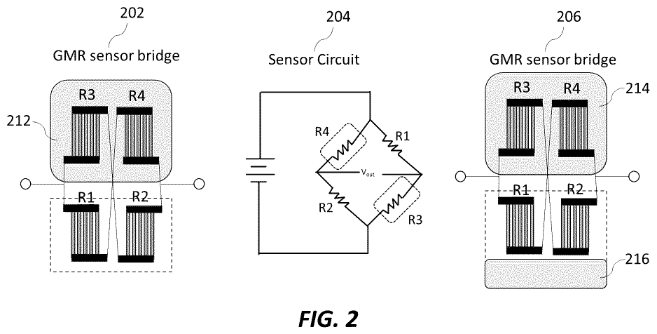

FIG. 2 illustrates an exemplary configuration of a GMR magnetic field sensor, in which four GMR sensors are arranged to form a Wheatstone bridge. Two of the GMR resistors, R3 and R4, are covered with a magnetic material 212 that shields them from the applied magnetic field. As a result, only the other two GMR resistors, R1 and R2, experience a reduction in resistance when an external magnetic field is applied. This imbalance generates an output voltage (Vout), as shown in 204. To further enhance the sensor's response, a magnetic flux concentrator is employed, as depicted in 206. The shield 214 and an additional magnetic material 216 work together to create a low reluctance path, which increases the magnetic field reaching GMR resistors R1 and R2, depending on their geometry, material properties, and the spacing between them.

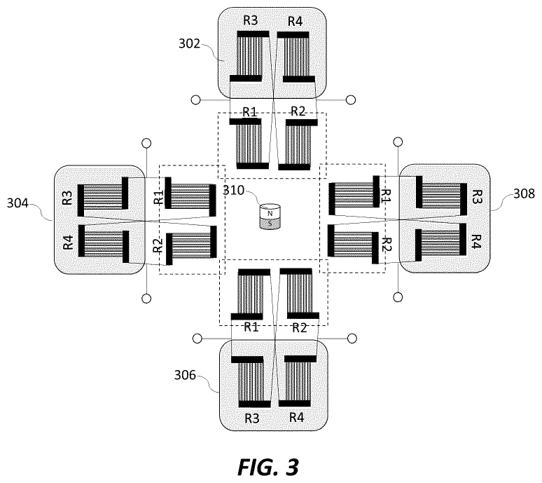

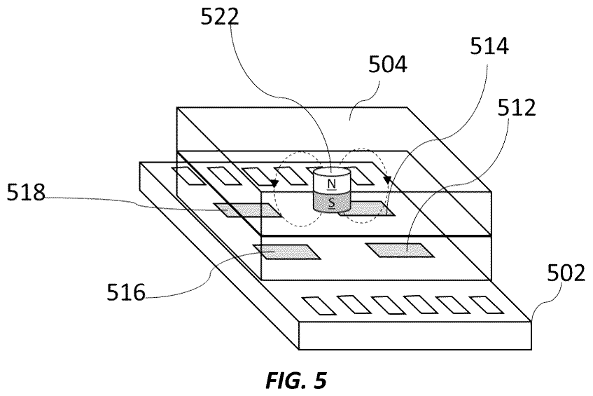

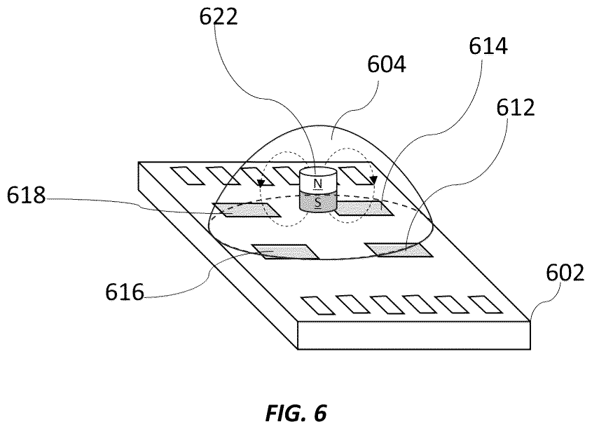

FIG. 3 illustrates an exemplary configuration of the tactile sensor setup, featuring GMR sensor bridges 302, 304, 306, and 308, along with a ferromagnet 310 embedded in an elastomer matrix (not shown but explained in FIG. 5 and FIG. 6). In this embodiment of the present teaching, the GMR sensor bridges do not include flux concentrators.

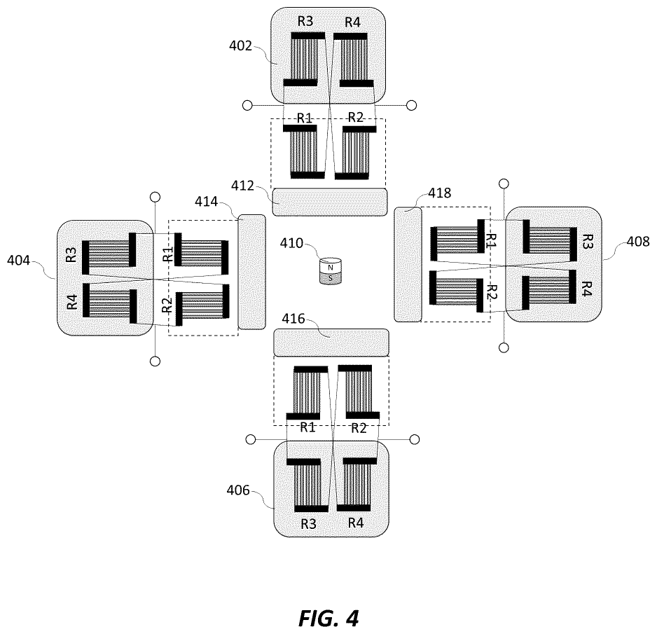

FIG. 4 illustrates another exemplary configuration of the tactile sensor setup, which includes GMR sensor bridges 402, 404, 406, and 408, as well as a ferromagnet 410 embedded in an elastomer matrix (not shown but explained in FIG. 5 and FIG. 6). In this configuration, the GMR sensor bridges incorporate flux concentrators 412, 414, 416, and 418, in accordance with an embodiment of the present teaching.

It should be clear to those skilled in the field that the configurations depicted in either FIG. 3 or FIG. 5 may have various modifications. For instance, the two exemplary configurations shown each feature four GMR bridges positioned at right angles to one another; however, they could be arranged at angles other than 90 degrees. While four GMR bridges are illustrated, the number of GMR bridges may vary, ranging from three to five, six, or more, as long as they form a closed loop that provides sufficient information for the computer to determine the magnitude and direction of the applied force on the sensor.

FIG. 5 illustrates an exemplary configuration of the tactile sensor setup, featuring GMR sensor bridges 512, 514, 516, and 518 (simplified from their actual dimensions) on a substrate 502. A ferromagnet 522 is embedded in an elastomer matrix 504, which has a flat top, as shown. It should be evident to those skilled in the field that the relative positioning of the four GMR bridges, the placement of the ferromagnet within the elastomer matrix, and the shape of the matrix itself can vary based on the specific performance requirements of the tactile sensor.

FIG. 6 illustrates another exemplary configuration of the tactile sensor setup, featuring GMR sensor bridges 612, 614, 616, and 618 (simplified from their actual dimensions) on a substrate 602. A ferromagnet 622 is embedded in an elastomer matrix 604, which has a cone shape, as shown. It should be clear to those skilled in the field that the relative positioning of the four GMR bridges, the placement of the ferromagnet within the elastomer matrix, and the shape of the matrix itself may vary based on the specific performance requirements of the tactile sensor.

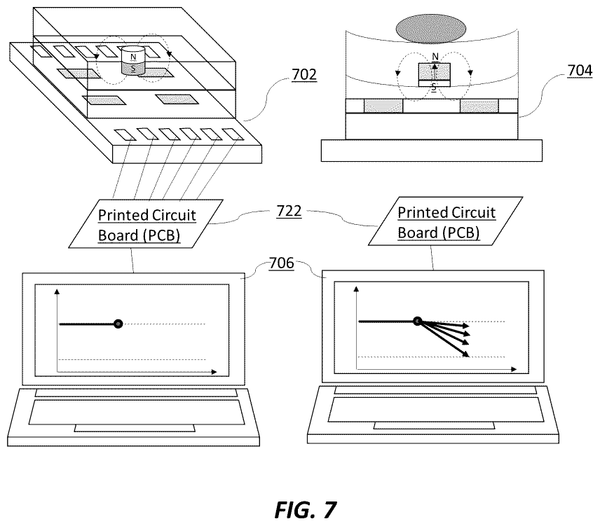

FIG. 7 illustrates how tactile sensor data is collected and processed. A printed circuit board (PCB) 722 connects the tactile sensor 702 to a computer 706, which can either be a standalone device or part of a larger system. The PCB supplies power to the tactile sensor, either through a constant voltage or constant current, and collects the output signals from all the GMR bridges, relaying this information to the computer. When the tactile sensor comes into contact with external objects, as depicted in the cross-sectional illustration 704, the elastomer deforms and displaces the embedded ferromagnet. This displacement alters the magnetic field and distribution, resulting in a change in the output signal from the GMR sensors.

There can be many instances in which the signals from the tactile sensors change upon contact. Typically, a calibration process is employed to establish a transfer function between the tactile sensor signals and the contact events. This calibration addresses both static and dynamic cases. Additionally, dedicated software algorithms should be developed and stored for tactile sensor applications.

The base substrate 502 and 602 used to fabricate the tactile sensor can be made of rigid materials such as silicon, GaAs, AlTiC, or flexible substrates such as polyimide, polyethylene terephthalate (PET), polyethylene-2,6-naphthalate (PEN), polydimethyl siloxane (PDMS), etc.

The elastomer 504 and 604, in accordance with various embodiments, may be comprised of natural rubbers, styrene-butadiene block copolymers, polyisoprene, polybutadiene, ethylene propylene rubber, ethylene propylene diene rubber, silicone elastomers, fluoroelastomers, polyurethane elastomers, and nitrile rubbers, etc.

The ferromagnet 522 and 622 can be made of various different materials, such as soft magnetic materials including iron, cobalt, nickel, and their alloys or permanent magnetic materials such as NbFeB, SmCo5, FePt, CoPt, etc. The top-down view shape of the ferromagnet can be circular, rectangular, square, or other shapes.

It should be clear to those skilled in the field that there are various options for GMR sensors and their contact materials, as documented in the literature, including journal articles, conference presentations, patents, and other sources.

While the preceding sections describe what is considered the best mode and other examples, it is understood that various modifications may be made, and the subject matter disclosed herein can be implemented in different forms and examples. Additionally, the teachings may be applied in numerous applications, some of which have been discussed here. The following claims are intended to encompass all applications, modifications, and variations that fall within the true scope of the present teachings.

We claim:

1. A tactile sensor device for detecting touch, comprising:
A substrate that includes multiple magnetic field sensors configured to sense a magnetic field generated by a ferromagnet in proximity to the magnetic field sensors;
A coating of an elastomer matrix that encapsulates the magnetic field sensors, with the ferromagnet embedded within it;
The displacement of the ferromagnet due to the deformation of the elastomer matrix when it comes into contact with an external object;
The calculation of the ferromagnet's displacement using a predefined algorithm.

2. The tactile sensor device of claim 1, wherein the magnetic field sensors with quantity of either three, or four, or five, or more, arranged such that their sensitive axes intersect directly beneath the ferromagnet.

3. The tactile sensor device of claim 1, wherein the magnetic field sensors are giant magnetoresistance sensors, with or without a flux concentrator.

4. The tactile sensor device of claim 1, wherein the magnetic field sensors form Wheatstone bridges, with active sensors oriented towards the center of the device and inactive sensors shielded from external magnetic fields by magnetic materials.

5. The tactile sensor device of claim 1, wherein the array of giant magnetoresistance sensors may include tunneling giant magnetoresistance (TGMR) sensors.

6. The substrate of claim 1, wherein the substrate is made from rigid materials such as silicon, GaAs, or AlTiC, or from flexible materials such as polyimide, polyethylene terephthalate (PET), polyethylene-2,6-naphthalate (PEN), or polydimethylsiloxane (PDMS).

7. The elastomer matrix of claim 1, wherein the elastomer matrix consists of materials such as natural rubbers, styrene-butadiene block copolymers, polyisoprene, polybutadiene, ethylene propylene rubber, ethylene propylene diene rubber, silicone elastomers, fluoroelastomers, polyurethane elastomers, and nitrile rubbers.

8. The ferromagnet of claim 1, wherein the ferromagnet is composed of soft magnetic materials such as iron, cobalt, and nickel, or their alloys, or of permanent magnetic materials such as NdFEB, SmCo alloys, FePt, and CoPt.

9. The ferromagnet of claim 1, wherein the ferromagnet may take on shapes such as circular, rectangular, or square when viewed from above.
